(19) United States
(12) Patent Application Publication
(10) Pub. No.: US 2022/0339502 A1
(43) Pub. Date: Oct. 27, 2022

(54) DYNAMIC LEADERBOARD VISUALIZATIONS IN A DISTRIBUTED ACTIVITY ENVIRONMENT

(71) Applicant: ECHELON FITNESS MULTIMEDIA LLC, Chattanooga, TN (US)

(72) Inventors: Lou LENTINE, Stuart, FL (US); John SANTO, Orlando, FL (US)

(21) Appl. No.: 17/725,140

(22) Filed: Apr. 20, 2022

Related U.S. Application Data
(60) Provisional application No. 63/177,716, filed on Apr. 21, 2021.

(51) Int. Cl. A63B 24/00; H04L 67/50; A63B 71/06

(52) U.S. Cl. CPC A63B 24/0084; H04L 67/535; A63B 24/0062; A63B 71/0622

(57) ABSTRACT

The disclosed embodiments are directed toward improvements in visualization of metrics generated by fitness devices. In one embodiment, a method is disclosed comprising receiving, at a fitness device over a network, activity data from a server, the activity data comprising data reported by other fitness devices during participation in an activity; extracting, by the fitness device, user data, position data, and output data from the activity data; and rendering, by the fitness device, a visualization of the activity data, the rendering comprising: rendering icons representing the user data relative to a baseline, a distance of each of the icons to the baseline determined based on the output data and spacing between the icons determined based on the position data, and rendering a curve, the curve connected to each of the icons.

### CROSS-REFERENCE TO RELATED APPLICATIONS

This application claims priority to U.S. Prov. Pat. Appl. No. 63/177,716 filed Apr. 21, 2021 and incorporated herein in its entirety.

### BACKGROUND

The disclosed embodiments are directed toward fitness equipment and, specifically, toward the generation of leaderboard visualizations in a geographically dispersed activity environment.

Traditionally, many fitness activities were undertaken as in-person endeavors. Spin, rowing, cycling, and other classes required the physical presence of participants to coordinate an activity under the guidance of a single teacher. As home exercise equipment became widely available, some users replaced or augmented fitness routines with personal (e.g., in-home, in-office, etc.) fitness equipment such as exercise bikes and rowing machines. However, this early equipment frequently provided rudimentary interfaces that only allowed users to see their current activity (e.g., speed, power, etc.).

More recently, network-enabled fitness equipment has allowed personal fitness equipment to “connect” to other network-enabled equipment. Such systems could allow users to virtually race one other while being physically dispersed. However, such systems still rely on rudimentary visualizations such as static leaderboards that fail to leverage the wealth of data generated in a distributed fitness activity.

### BRIEF SUMMARY

The disclosed embodiments solve these and other problems in the current state of the art. The disclosed embodiments describe a distributed fitness environment whereby activity metrics recorded locally by individual fitness equipment or devices are synchronized with a central cache or database. The fitness equipment generates these activity metrics during live classes or during archived classes. In a live class, a user of the fitness equipment competes with other users of other fitness equipment. In an archived class, the user of the fitness equipment competes with past users of a class or activity. In some embodiments, the past users may include or consist of the user themselves; that is, the past users may include a user's previous engagement with the class or activity.

A publish-subscribe architecture is provided whereby activity metrics are published and consumed by the fitness equipment. Thus, fitness equipment receives raw data representing the current state of the users participating in an activity. In turn, the fitness equipment can then generate visualizations of the raw data for display on a screen of the fitness equipment.

In one embodiment, the visualizations include a sinusoidal visualization. In this embodiment, a graph of a continuous is depicted on the screen. In some embodiments, the continuous line is substantially sinusoidal and smooth. In one embodiment, the continuous line includes various peaks and valleys. In one embodiment, the continuous line includes a series of points, wherein each point corresponds to a participant in the activity. In one embodiment, the height of any given point of the continuous line with respect to a baseline is computed based on the output of the participants. In one embodiment, the locations of the points associated with each participant are determined based on the participants' relative positions in the activity with respect to one another. In one embodiment, the visualization is created by generating an initial sine curve having a set frequency and amplitude. Next, the points associated with participants are placed on the sine curve based on their respective ordering. Next, the vertical position of the points is determined based on the respective current output. Finally, the original points of the sine curve are adjusted to match the determined points, and the entire sine curve is smoothed to generate a new, potentially variable amplitude sine curve. By using and displaying the data described herein in the various embodiments, a user is provided with a more robust and easier to intuitively understand visual representation of the event or activity in which they are participating. These and other visualizations are described more fully in the following description.

### BRIEF DESCRIPTION OF THE DRAWINGS

The preceding and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure.

FIG. 1 is a user interface diagram of a user interface (UI) displayed on a fitness device according to some embodiments of the disclosure.

FIG. 2 is a user interface diagram of a leaderboard displayed on a fitness device according to some embodiments of the disclosure.

FIG. 3 is a user interface diagram of the main window displayed on a fitness device according to some embodiments of the disclosure.

FIG. 4 is a flow diagram illustrating a method for generating a visualization on a fitness device according to some embodiments of the disclosure.

FIG. 5 is a flow diagram illustrating a method for propagating activity data according to some embodiments of the disclosure.

FIG. 6 is a block diagram of a system 600 for distributing and visualizing leaderboard data according to some embodiments of the disclosure.

FIG. 7 is a block diagram illustrating a computing device showing an example of a client or server device used in the various embodiments of the disclosure.

### DETAILED DESCRIPTION

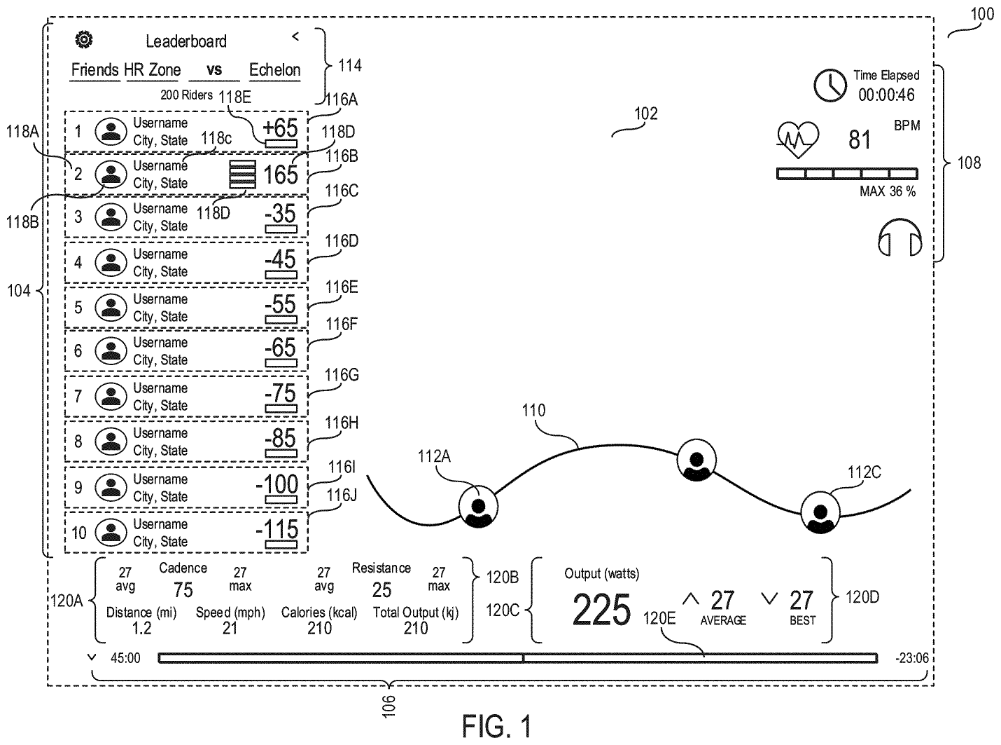

FIG. 1 is a user interface diagram of a user interface (UI) displayed on a fitness device according to some embodiments of the disclosure.

In the illustrated embodiment, a user interface 100 includes a plurality of components, including a main window 102, a leaderboard 104, a status panel 106, and a heads-up display 108. The specific arrangement of the components is not intended to be limiting.

In the illustrated embodiment, the leaderboard 104 includes a header portion that includes a title label and a plurality of tabs 114. In one embodiment, the tabs 114 allows a user to toggle between various leaderboard views. In the illustrated embodiment, a versus leaderboard view is illustrated. In this view, all users performing the activity (either in real-time or in archived mode) are ranked based on their position in the activity. For example, if the activity is cycling or rowing, the users can be ranked based on their total distance cycled. Other techniques can be used to rank users, and the disclosure is not limited in that regard.

In some embodiments, leaderboard 104 is scrollable. Thus, while only ten users are listed, a user can scroll to view all users in ranked order. In some embodiments, the device implementing the user interface 100 will only load a subset of all riders for display and will issue a network request to pre-load additional riders as the user scrolls (e.g., fifty at a time). In other embodiments, the user interface 100 will pre-load all users to reduce the lag during scrolling.

In the illustrated embodiment, leaderboard 104 includes a plurality of panels 116a-116j, each panel associated with a user. Each panel may include a rank number 118a, a profile picture or icon 118b, descriptive text 118c, a relative position 118d, a current output indicator 118e, and a power meter 118f.

In the illustrated embodiment, the rank number 118a comprises an integer ranking of the users. As illustrated, users are ranked from one to the total number of users. In the illustrated embodiment, this rank number 118a comprises the sorting key when sorting users. In other embodiments, the users are ranked by a metric (e.g., distance) and then assigned a rank number 118a.

In the illustrated embodiment, the profile picture or icon 118b may comprise a user-uploaded image or a stock image or a live image of the user as they engage in the activity. In one embodiment, icon 118b is associated with an image file transmitted to the fitness device implementing the UI. In other embodiments, the icon 118b is associated with a uniform resource locator (URL) that is dynamically downloaded when referenced in the UI. In some embodiments, the icon 118b may be augmented with badges or other indicators. In some embodiments, these badges or other indicators may comprise awards, progress indicators, or other graphics.

In the illustrated embodiment, the descriptive text 118c comprises text associated with a given user. For example, the descriptive text 118c can comprise a username, city, state, or other text data associated with the user.

In the illustrated embodiment, the relative position 118d comprises an integer value that indicates the relative position of users. In the illustrated embodiment, current user panel 116b is associated with a user using the fitness device implementing the user interface 100. In one embodiment, the relative position 118d comprises the total output of a user. In one embodiment, the output of a user refers to a value generated based on the recorded sensor data of the fitness device. For example, an exercise bike may compute an output value based on the revolutions per minute (rpm) and the current resistance level. As another example, a rowing machine may use a stroke rate and split rate to compute an output level. Although output level is used as an example, other comparable values may be used. For example, the relative position 118d may comprise a total traveled distance during an activity, a total time performing the activity, or other value. In general, however, the relative position 118d may comprise an aggregated or total value versus an instantaneous value.

In the illustrated embodiment, panels 116a and 116c through 118j include a current output indicator 118e. In the illustrated embodiment, the current user's panel 116b does not include such an indicator. In some embodiments, however, the current user panel 116b may include such an indicator. The current output indicator 118e can comprise a visual indicator of a current output level. In one embodiment, the current output indicator 118e comprises a rectangular (or another shape) solid that changes color based on the instantaneous output of each user. In one embodiment, an instantaneous output is categorized into categories to assist in color determination. For example, an instantaneous output may be categorized as high (red), medium (orange), low (yellow), or idle (green). Thus, the current output indicator 118e changes colors based on the current output of a given user. In this manner, the current outputs of all users can be quickly understood by the current user. In some embodiments, the current output indicator 118e may further be adjusted in other ways based on the current output. For example, the width of the current output indicator 118e may be adjusted in a similar fashion. That is, the width may be adjusted to 100% (high), 75% (medium), 50% (low), or 25% (idle) of the maximum width based on the instantaneous output.

In the illustrated embodiment, the current user panel 116b does not include a current output indicator 118e. By contrast, in the illustrated embodiment, the current user panel 116b includes a power meter 118f. In the illustrated embodiment, the power meter 118f comprises a meter level indicating a user's current output. In some embodiments, the power meter 118f uses the same strategy for indicating current output. However, in the illustrated embodiment, the power meter 118f comprises a vertical stack of bars indicating instantaneous output. Continuing the previous example, in one embodiment, the lowermost bar comprises a green (idle) bar, followed upwardly by an orange bar (low), yellow bar (medium), and red bar (high). As the current user's instantaneous output changes, the appropriate bar is displayed, all bars under the appropriate bar are also displayed, and all bars above the appropriate bar are not displayed.

As discussed, leaderboard 104 comprises one example of a leaderboard. Another example of a leaderboard is further discussed herein.

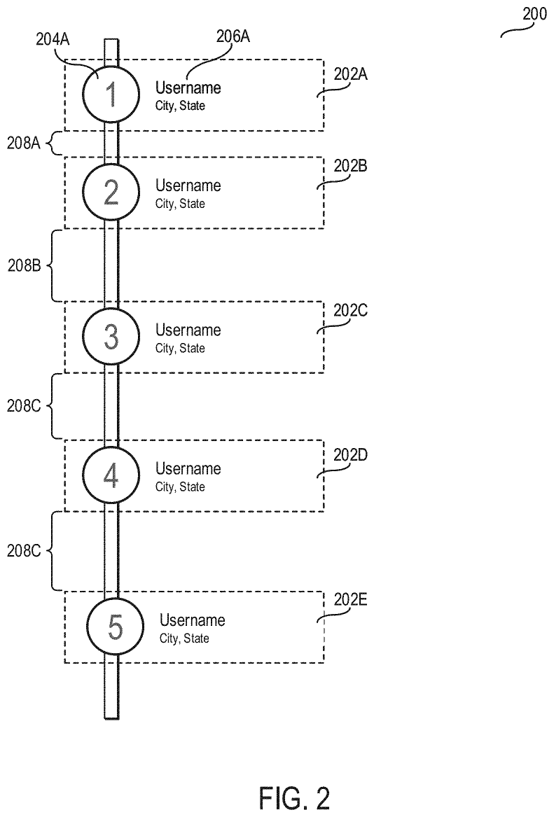

FIG. 2 is a user interface diagram of a leaderboard 200 displayed on a fitness device according to some embodiments of the disclosure. In some embodiments, the leaderboard 200 may display in lieu of leaderboard 104 of FIG. 1.

In the illustrated embodiment, a leaderboard 200 includes a plurality of panels 202a-202e. The specific number of panels is not limiting. As with leaderboard 104, the leaderboard 200 ranks the users associated with panels 202a-202e based on a comparable metric (e.g., total output). A given panel 202a is given an icon 204a and includes descriptive text 206a. Details of these elements are similar to rank number 118a and descriptive text 118c, respectively, and those details are not repeated herein. In the illustrated embodiment, a given panel 202a includes an icon 204a. In one embodiment, icon 204a comprises a user profile picture or a stock image. In other embodiments, icon 204a comprises a ranking image (e.g., an image of the user's integer rank). In some embodiments, an integer ranking may be overlaid on top of an image of the respective user.

In contrast to user interface 100, leaderboard 200 includes variable spacing 208a-208d between panels 202a-202e. In one embodiment, the spacing 208a-208d is determine based on the difference between outputs of adjacent panels 202a-202e. For example, the output levels associated with panels 202a and 202b may comprise 180 and 160, respectively; thus, the difference is 20. In one embodiment, the spacing 208a may be computed as 20 pixels. Similarly, the output levels of panels 202b and 202c may comprise 160 and 100. Thus, the spacing 208b may be computed as 60 pixels.

In some embodiments, the spacing 208a-208d may be adjusted based on the number of panels and the available space. For example, if the distance between panels 202a and 202b is too large, the leaderboard 200 may only display two or even one panels. In some embodiments, the leaderboard 200 will attempt to display a constant number of users (e.g., five). Thus, the leaderboard 200 can evenly space the panels 202a-202e first and determine the available spacing 208a-208d. Next, the leaderboard 200 can represent the distances between panels 202a-202e as a percentage of the available space. For example, if each panel is 50 pixels high, 250 pixels are needed to render the panels. If the total height of the leader board is 450 pixels, then 200 pixels of spacing is available. If the difference in total output between the riders is equal (e.g., 50), the spacing 208a-208d is evenly divided among the 200 pixels. Thus, each spacing 208a-208d is set to 50 pixels. However, if the distance between panels 202a and 202b increases to 100 while the distances between the other panels remain 50, the leaderboard 200 may adjust the spacing by computing the distance percentage between panels 202a and 202b (e.g., 100/(100+50+50+50)=40%) as well as the percentages for the remaining spacings (e.g., 50/(100+50+50+50)=20%). The leaderboard 200 will then use these percentages to compute the spacings 208a, 208b, 208c, and 208d as 80, 40, 40, and 40 pixels, respectively. In this manner, a fixed number of panels 202a-202e can be displayed at any moment.

Returning to FIG. 1, the user interface 100 can further include a status panel 106. In the illustrated embodiment, status panel 106 includes various metrics 120a-120d measured for a current user's participation in an activity. For example, as illustrated, the status panel 106 includes a user's cadence, resistance level, total output (in watts). As illustrated, status panel 106 may display an instantaneous value for each of these metrics as well as average and maximum recorded values for a given activity. In some embodiments, the status panel 106 further includes data such as distance, speed, calories burned, and a progress bar 120e indicating the user's progress in performing an activity.

The user interface 100 may further include a heads-up display 108. In the illustrated embodiment, the heads-up display 108 may include various details of the activity such as the time elapsed, a heart rate, heart rate training zones, etc.

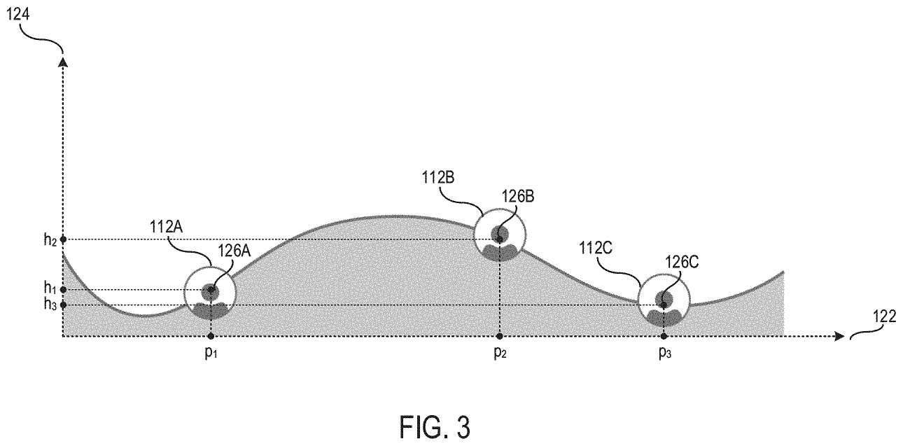

In the illustrated embodiment, the user interface 100 includes a main window 102. In the illustrated embodiment, main window 102 includes a curved graph 110 having a plurality of icons 112a-112c situated thereon. The detail of graph 110 is expanded upon in FIG. 3.

In the various embodiments described above, a user may be able to minimize, hide, collapse, or otherwise manipulate the various sections 102, 104, 106, and 108 of the user interface 100. For example, the user may be able to swipe leaderboard 104 to the left (via a capacitive touchscreen) to hide the leaderboard 104. The user may then be able to swipe right from the edge of the screen to display the leaderboard 104 again. In another embodiment, icons may be presented on sections 102, 104, 106, and 108 to hide the sections. In these embodiments, sections 102, 104, 106, and 108 may be overlaid on top of a full-screen video stream. In some embodiments, sections 102, 104, 106, and 108 may be opaque, while in others, some or all of the sections 102, 104, 106, and 108 may be translucent.

In the illustrated embodiment, a single curve 110 is illustrated having multiple icons 112a-112c situated thereon. However, in other embodiments, multiple curves may be presented, one for each of the icons 112a-112c. In this embodiment, the curves for each of the icons 112a-112c may be identical and the positioning of each of the icons 112a-112c may be performed in a similar manner as described. However, in this embodiment, each graph only shows a single icon of the icons 112a-112c. In one embodiment, the graphs may be aligned along the bottom of the main window 102.

FIG. 3 is a user interface diagram of the main window displayed on a fitness device according to some embodiments of the disclosure.

In the illustrated embodiment, the curved graph 110 comprises a sinusoidal curve, although other types of curves can be used, such as parabolic curves, etc. In the illustrated embodiment, a plurality of icons 112a-112c is positioned along the curve 110. Each icon 112a is associated with a corresponding center 126a-126c. In some embodiments, the centers comprise a point equidistant from every point on the perimeter of icons 112a-112c. In other embodiments, other points may be used. In the illustrated embodiment, the centers 126a-126c are situated along the curve 110.

In the illustrated embodiment, a y-axis 124 and x-axis 122 are illustrated, with an original at the intersection of the y-axis 124 and x-axis 122. The y-axis 124 and x-axis 122 are illustrated solely for explanation purposes and do not appear in the visualization. In the illustrated embodiment, the centers 126a-126c of each icon 112a-112c are associated with a point relative to the origin of the y-axis 124 and x-axis 122. Thus, icon 112a is associated with a center 126a having coordinates of (p₁, h₁). In the illustrated embodiment, the position points (p₁, p₂, p₃) are determined based on the ranking of the users, as discussed with respect to icon 118b. Thus, in a racing scenario, the user associated with icon 112c leads the user associated with icon 112b, and the user associated with icon 112b leads the user associated with icon 112a (i.e., p₃>p₂>p₁).

In the illustrated embodiment, the height (i.e., distance from x-axis 122) is determined based on the instantaneous output of the users associated with icons 112a-112c. For example, the current energy output (e.g., in kilojoules) may be used to compute the heights h₁, h₂, h₃. In one embodiment, the heights are normalized to fit within a maximum height of the main window 102.

In one embodiment, the centers 126a-126c are used to fit the formula of the curve 110. In one embodiment, a sinusoidal model is used to generate a formulaic representation of the curve 110 which is then used to render the points along the curve, including centers 126a-126c used to place the icons 112a-112c. In other embodiments, a default curve may be used first and the coordinates of centers 126a-126c may be used to adjust coordinates of the default curve. The curve 110 may then be adjusted to match these coordinates, resulting in the final curve. Notably, the curve may have a varying amplitude and frequency.

In one embodiment, the coordinates of the centers 126a-126c change through the performance of an activity. Thus, the heights and positions of the centers 126a-126c may be moving throughout the activity. In this scenario, the display of the curve 110 is redrawn each time a center 126a-126c change position, thus moving along with the change in instantaneous output and positions.

In general, curve 110 may be represented by, for example, the formula y(t)=h(t) sin(p(t)), where h(t) is a function outputting the time-varying height of the centers 126a-126c and p(t) represents the time-varying positions of the centers 126a-126c.

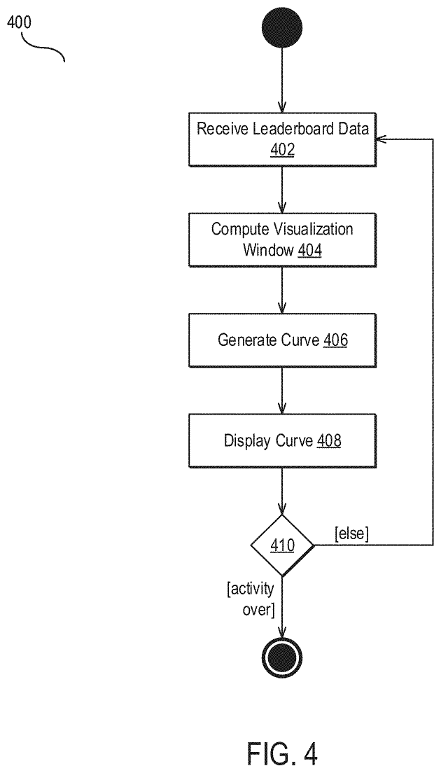

FIG. 4 is a flow diagram illustrating a method for generating a visualization on a fitness device according to some embodiments of the disclosure.

In step 402, the method 400 receives leaderboard data.

In one embodiment, step 402 includes receiving, at a fitness device over a network, activity data from a server, the activity data comprising data reported by other fitness devices during participation in an activity. In one embodiment, step 402 includes extracting user data, position data, and output data from the activity or leaderboard data.

In the illustrated embodiment, while a user is participating in an activity (e.g., cycling class, rowing class, running class, etc.) the fitness device periodically receives leaderboard data from a remote computing device (e.g., server). As discussed in the previous figures, this leaderboard data comprises a ranked list of users also participating in the activity, either in real- or near-real time or from an archived class. For example, the data may include user data, a current total output, and an instantaneous output:

```
[
  {“user”: 1, “output”: 250, “instantaneous”: “50”},
  {“user”: 3, “output”: 220, “instantaneous”: “75”},
  {“user”: 2, “output”: 200, “instantaneous”: “90”},
]
```

As illustrated, the data may be pre-sorted by, for example, a total output. This sorting corresponds to the rankings described above. In some embodiments, the data may be unsorted and sorted by the fitness device.

In some embodiments, the leaderboard data is received for a live class. In this embodiment, the leaderboard data comprises data associated with users participating in the live activity at the current time. In other embodiments, the leaderboard data is received for an archived activity. In these embodiments, the leaderboard data comprises data associated with users participating in an archived activity at a given moment of playback of the archived activity.

In step 404, the method 400 computes a visualization window for displaying leaderboard data.

In one embodiment, the leaderboard data includes data of the current user of the fitness device executing the method. For example, the fitness device may transmit its instantaneous and total output to a central server and may receive, in response, updated leaderboard data that includes their uploaded data and all other data associated with users performing (or that have performed) the activity. In another embodiment, the leaderboard may not include the current user's data but rather the current user's data may be recorded locally. In these embodiments, the method 400 may include inserting the local data into the received leaderboard data in the appropriate ordered location.

In either scenario, the visualization window refers to a subset of the data in the leaderboard data. For example, the visualization window may comprise five total users in the leaderboard data. In one embodiment, the method 400 centers the visualization window around a current user and selects an equal number of users that are ranked higher and lower than the current user. For example, if the visualization window comprises five users, the method 400 may select the two users ahead of the current user and the two users behind the current user. If the current user is the first user in the ordering, the method 400 may select four users after the current user and if the current user is the last user, the method 400 may select four users ahead of the current user.

In step 406, the method 400 generates a curve based on the leaderboard data in the visualization window.

In one embodiment, the method 400 generates a curve by fitting a curve to the data selected for the visualization window. As discussed, in one embodiment, the method 400 may compute coordinates for each piece of user data. In one embodiment, the method 400 selects the middle user in the visualization window which, as an example, may be the current user.

In one embodiment, the method 400 generates a curve by generating a base curve. In one embodiment, the method 400 generates a base sinusoidal curve. In one embodiment, the frequency and amplitude of the base curve are determined based on the available area to render the curve. For example, the method 400 may select a frequency such that two periods are visible in the available area. The method 400 may further center the curve vertically such that the amplitude is one-half of the height of the available area. Other determinations may be made. After generating an initial curve, the method 400 plots the leaderboard in the visualization window. As discussed, in one embodiment, the data in the leaderboard may be used to generate an x and y position for each data point. The method 400 superimposes these points on the base curve and then adjusts the curve based on the plotted points. For example, the method 400 may select each point and identify a point on the base curve having the same x position (but potentially different y position). The method 400 will then adjust the y position of that point on the curve to match the corresponding leaderboard data point. After adjusting the points, the method 400 smooths all remaining points of the curve to render a final continuous curve.

In an alternative embodiment, the method 400 may use the leaderboard data as an initial set of points and fit a curve to those points. As discussed, the metrics in the leaderboard data may be used as x and y coordinates of the initial set of points. Using this set, the method 400 may fit a curve (e.g., sinusoidal, n-degree polynomial) to the initial set of points.

In step 408, the method 400 renders the curve. In one embodiment, the method 400 comprises displaying the curve in a main window of UI. In one embodiment, the method 400 may scale the rendering of the curve to fit within a preconfigured area of the main window.

In step 410, the method 400 determines if the activity is over. If not, the method 400 continuously re-executes steps 402, 404, 406, and 408. Alternatively, if the method 400 determines if the activity is over, the method 400 ends.

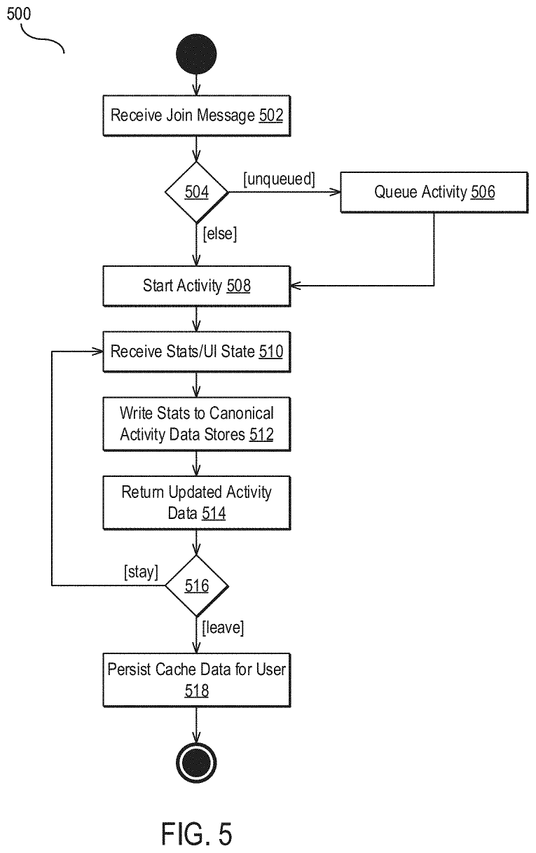

FIG. 5 is a flow diagram illustrating a method (500) for propagating activity data according to some embodiments of the disclosure. In some embodiments, the method (500) can be executed by a single server. In other embodiments, the method (500) may be executed by a cloud platform comprising a plurality of physical servers and virtualized servers or containers.

In step 502, the method 500 receives a join message. In one embodiment, the method 500 receives the join message from a given fitness device. In one embodiment, the join message includes an activity identifier or similar mechanism to identify an activity to join. For example, if the activity comprises a spin class, the identifier may comprise a class identifier. In one embodiment, the join message further includes information identifying the requesting user and/or the fitness device. For example, the join message may further include a user identifier or account name. In some embodiments, the join message is transmitted over a socket-based connection such as a WebSocket connection.

In step 504, the method 500 determines if the activity is queued. In one embodiment, in response to a join message, the method 500 will determine if a data structure representing the activity is present in a cache data store. If so, the method 500 will bypass step 506. Alternatively, if the method 500 determines that the activity is not queued, it queues the activity in step 506.

In one embodiment, a given activity is associated with set of participants and each participant is associated with metrics representing their performance of that activity. In the illustrated embodiment, the cache data store maintains, for each active activity, an in-cache representation of this leaderboard data.

If the join message is the first user of a live class, no such data will be cached. Thus, the method 500 will create an initial data structure as part of queuing the activity in step 506. In one embodiment, creating the initial data structure may comprise creating a representation of the user that issued the join message in the leaderboard data structure and writing the leaderboard data structure to the cache. Alternatively, if the join message is received from a subsequent user, the method 500 will determine that the activity is queued and will simply add the user to the leaderboard. For archived activity, the process is similar. In some embodiments, when a user requests an archived activity, the method 500 will proceed to step 506 to create an initial leaderboard. The method 500 may then query a database to identify past performances of the activity and populate the leaderboard with data from those past performances. In some embodiments, these past performances may comprise other users that have completed the activity in the past. Alternatively, or in conjunction with the foregoing, the other users may include the same user's past performances (i.e., the current user can compete against themselves).

Once the activity is properly queued, the method 500 proceeds to start the activity in step 508. For live activities, the method 500 may comprise awaiting a global start timestamp. Once the current time is equal to the global start timestamp, the method 500 may stream live video content. Concurrently, the method 500 will proceed to step 510 to begin collecting statistics from live participants. For archived classes, the method 500 may immediately begin streaming archived video content and proceed to step 510 to begin collecting statistics from the current user. Concurrently, for archived classes, the method 500 may continuously update the cached leaderboard data based on historical performance data.

In step 510, the method 500 receives activity statistics and UI state data from a fitness device. In one embodiment, statistics refer to measurable performance of the activity. For example, the measurable performance may comprise the current output of a spin bike or rowing machine. In some embodiments, the statistics maybe timestamped. In some embodiments, the timestamping is relative to a streaming or archived video stream. In one embodiment, UI state data may comprise the displayed users on a given fitness device at a given time. For example, the method 500 may receive the visualization window discussed previously. In other embodiments, the UI state data may comprise a request for a new set of leaderboard data for a current time. In some embodiments, the statistics and UI state data are combined in a single message. However, in some embodiments, the messages are separate. In a separated example, the method 500 may receive statistics at a more rapid (i.e., near real-time) frequency than UI state data requests.

In step 512, the method 500 writes the stats to the canonical activity data stores. In one embodiment, the method 500 persists the received states to a database or similar long-term storage. These persisted data points can then be used for archived classes. In some embodiments, the method 500 may further write the stats to the cache.

In step 514, the method 500 returns updated activity. In one embodiment, the method 500 returns the leaderboard data (discussed previously). In one embodiment, the method 500 returns the leaderboard data in response to a UI state data request. In some embodiments, this request is separate from an update of statistics, as discussed. An example of the format of the returned leaderboard data has been described previously and is not repeated herein. In one embodiment, the method 500 reads the current leaderboard data for the identified class by querying the cache and retrieving the most recent leaderboard data. In some embodiments, the method 500 may further sort the leaderboard data prior to returning it.

In step 516, the method 500 determines if a leave message was received. In one embodiment, a fitness device may transmit a leave message upon exiting an activity. If the user remains in an activity, the method 500 continuously executes steps 510, 512, and 514 until the user leaves the activity or the activity ends.

In step 518, after the user leaves the activity, the method 500 persists the cached data for the user in a persistent data store. In one embodiment, the method 500 may further remove the user data from the cache data store, thus preventing the user from being displayed on other leaderboards. By persisting the data, the user data can be re-used during archived classes.

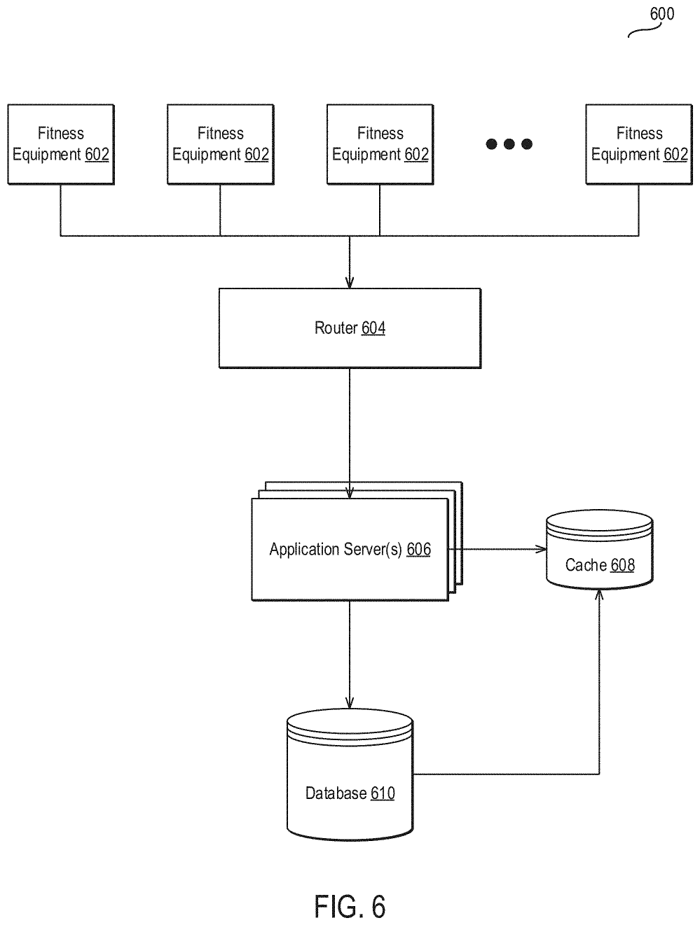

FIG. 6 is a block diagram of a system 600 for distributing and visualizing leaderboard data according to some embodiments of the disclosure.

In the illustrated embodiment, a system 600 includes plurality of fitness devices 602 are communicatively coupled to a router 604. In the illustrated embodiment, the fitness devices 602 may comprise any equipment configured to monitor activity performance of a user. Examples of fitness devices 602 include, but are not limited to, spin bikes, stationary bikes, rowing machines, fitness mirrors, weightlifting apparatuses, and other types of fitness-related equipment. In general, any device capable of capturing an activity metric may be used. Examples of activity metrics include power output or resistance for spin bikes, stroke rate and split time for rowing machines, calories burned, heartrate, etc. In some embodiments, fitness devices 602 may comprise computing devices not specifically designed for fitness. For example, a smart watch may comprise a fitness device and may record a current lap number (or distance) while a user is swimming. The aforementioned visualization can be displayed on the watch and updated based on the measured laps (or distance).

In the illustrated embodiment, the fitness devices 602 transmit and receive data via router 604. In one embodiment, the router 604 comprises a message broker or similar application/hardware that receives messages and routes messages to the appropriate server in the application servers 606. In one embodiment, the router 604 may comprise a publish-subscribe broker, although other routers may be used. As discussed in connection with FIG. 5, the router 604 receives messages such as join, stats, UI state, and leave messages.

In the illustrated embodiment, the system 600 includes a plurality of application servers 606. In one embodiment, these application servers 606 comprise dedicated hardware devices. However, in other embodiments, the application servers 606 comprise virtualized servers or functions. For example, each of the application servers 606 may comprise a software container or other type of virtualized application that may be deployed on various hardware. In some embodiments, each server in the application servers 606 implements a single function. In some embodiments, multiple application servers 606 may implement a single function. In some embodiments, the application servers 606 perform some of all of the steps described in FIG. 5, which are not repeated in detail herein.

The system 600 includes a cache 608 communicatively coupled to the application servers 606. The cache 608 may comprise an in-memory data store such as Redis or similar type storage mechanisms. In the illustrated embodiment, the cache 608 stores data related to live activities or to archived activities that are being replayed. In one embodiment, the cache 608 stores a leaderboard for each activity. In one embodiment, the cache 608 includes internal sorting functionality (e.g., via a Redis SortedSet) to enable rapid sorting of large data volumes. In the illustrated embodiment, the cache 608 can further allow arbitrary reads and writes to data structures stored within.

In the illustrated embodiment, the system 600 further includes at least one database 610. In the illustrated embodiment, the least one database 610 may comprise a database cluster. In other embodiments, the database 610 may comprise a big data storage platform. In general, the least one database 610 is configured to store all recorded data for all activities. This includes all data recorded during a live activity as well as all data generated during a replay of an archived activity.

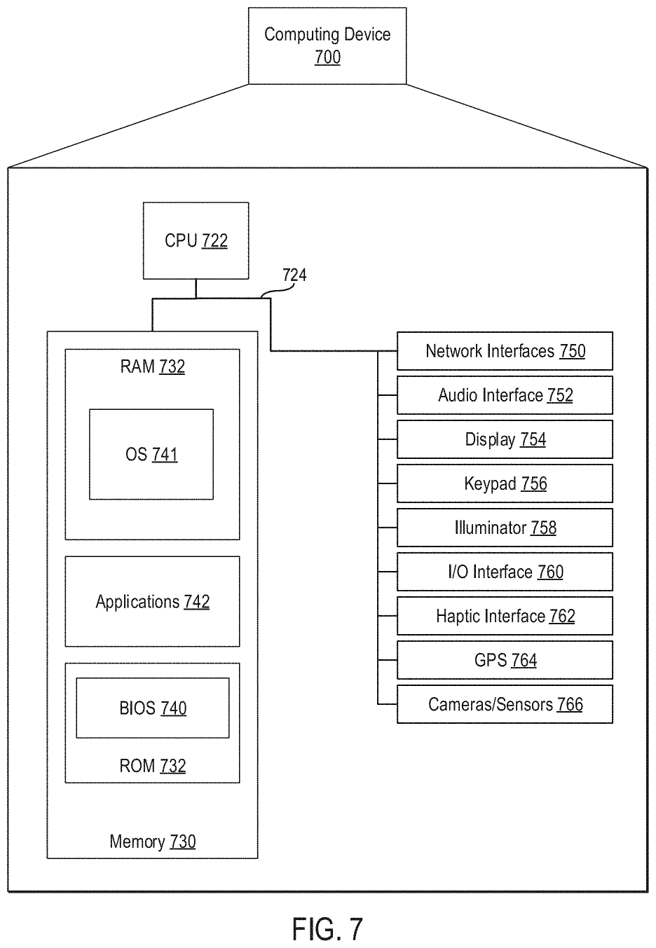

FIG. 7 is a block diagram illustrating a computing device showing an example of a client or server device used in the various embodiments of the disclosure.

The computing device 700 may include more or fewer components than those shown in FIG. 7, depending on the deployment or usage of the device 700. For example, a server computing device, such as a rack-mounted server, may not include an audio interface 752, display 754, keypad 756, illuminator 758, haptic interface 762, Global Positioning Service (GPS) receiver 764, or cameras/sensor 766. Some devices may include additional components not shown, such as graphics processing unit (GPU) devices, cryptographic co-processors, artificial intelligence (AI) accelerators, or other peripheral devices.

As shown in the figure, the device 700 includes a central processing unit (CPU) 722 in communication with a mass memory 730 via a bus 724. The computing device 700 also includes one or more network interfaces 750, an audio interface 752, a display 754, a keypad 756, an illuminator 758, an input/output interface 760, a haptic interface 762, an optional GPS receiver 764 and a camera(s) or other optical, thermal, or electromagnetic sensors 766. Device 700 can include one camera/sensor 766 or a plurality of cameras/sensors 766. The positioning of the camera(s)/sensor(s) 766 on the device 700 can change per device 700 model, per device 700 capabilities, and the like, or some combination thereof. In some embodiments, the sensors 766 may comprise fitness-specific sensors such as a revolutions per minute sensor on a spin bike or an ergometer on a rowing machine.

In some embodiments, the CPU 722 may comprise a general-purpose CPU. The CPU 722 may comprise a single-core or multiple-core CPU. The CPU 722 may comprise a system-on-a-chip (SoC) or a similar embedded system. In some embodiments, a GPU may be used in place of, or in combination with, a CPU 722. Mass memory 730 may comprise a dynamic random-access memory (DRAM) device, a static random-access memory device (SRAM), or a Flash (e.g., NAND Flash memory device). In some embodiments, mass memory 730 may comprise a combination of such memory types. In one embodiment, the bus 724 may comprise a Peripheral Component Interconnect Express (PCIe) bus. In some embodiments, the bus 724 may comprise multiple busses instead of a single bus.

Mass memory 730 illustrates another example of computer storage media for the storage of information such as computer-readable instructions, data structures, program modules, or other data. Mass memory 730 stores a basic input/output system (“BIOS”) 740 for controlling the low-level operation of the computing device 700. The mass memory also stores an operating system 741 for controlling the operation of the computing device 700

Applications 742 may include computer-executable instructions which, when executed by the computing device 700, perform any of the methods (or portions of the methods) described previously in the description of the preceding Figures. In some embodiments, the software or programs implementing the method embodiments can be read from a hard disk drive (not illustrated and temporarily stored in RAM 732 by CPU 722. CPU 722 may then read the software or data from RAM 732, process them, and store them to RAM 732 again.

The computing device 700 may optionally communicate with a base station (not shown) or directly with another computing device. Network interface 750 is sometimes known as a transceiver, transceiving device, or network interface card (NIC).

The audio interface 752 produces and receives audio signals such as the sound of a human voice. For example, the audio interface 752 may be coupled to a speaker and microphone (not shown) to enable telecommunication with others or generate an audio acknowledgment for some action. Display 754 may be a liquid crystal display (LCD), gas plasma, light-emitting diode (LED), or any other type of display used with a computing device. Display 754 may also include a touch-sensitive screen arranged to receive input from an object such as a stylus or a digit from a human hand.

Keypad 756 may comprise any input device arranged to receive input from a user. Illuminator 758 may provide a status indication or provide light.

The computing device 700 also comprises an input/output interface 760 for communicating with external devices, using communication technologies, such as USB, infrared, Bluetooth™, or the like. The haptic interface 762 provides tactile feedback to a user of the client device.

The optional GPS receiver 764 can determine the physical coordinates of the computing device 700 on the surface of the Earth, which typically outputs a location as latitude and longitude values. GPS receiver 764 can also employ other geo-positioning mechanisms, including, but not limited to, triangulation, assisted GPS (AGPS), E-OTD, CI, SAI, ETA, BSS, or the like, to further determine the physical location of the computing device 700 on the surface of the Earth. In one embodiment, however, the computing device 700 may communicate through other components, provide other information that may be employed to determine a physical location of the device, including, for example, a MAC address, IP address, or the like.

The present disclosure has been described with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in some embodiments” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure has been described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure, a non-transitory computer readable medium (or computer-readable storage medium/media) stores computer data, which data can include computer program code (or computer-executable instructions) that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

In the preceding specification, various example embodiments have been described with reference to the accompanying drawings. However, it will be evident that various modifications and changes may be made thereto, and additional embodiments may be implemented without departing from the broader scope of the disclosed embodiments as set forth in the claims that follow. The specification and drawings are accordingly to be regarded in an illustrative rather than restrictive sense.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to the desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. Such a computer program can be stored in a computer-readable storage medium, such as but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product or software that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as read-only memory (“ROM”), random access memory (“RAM”), magnetic disk storage media, optical storage media, flash memory components, etc.

In this description, various functions and operations are described as being performed by or caused by computer instructions to simplify the description. However, those skilled in the art will recognize what is meant by such expressions is that the functions result from the execution of the computer instructions by one or more controllers or processors, such as a microprocessor. Alternatively, or in combination, the functions and operations can be implemented using special-purpose circuitry, with or without software instructions, such as using Application-Specific Integrated Circuit (ASIC) or Field-Programmable Gate Array (FPGA). Embodiments can be implemented using hardwired circuitry without software instructions or in combination with software instructions. Thus, the techniques are limited neither to any specific combination of hardware circuitry and software nor to any particular source for the instructions executed by the data processing system.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
receiving, at a fitness device over a network, activity data from a server, the activity data comprising data reported by other fitness devices during participation in an activity;
extracting, by the fitness device, user data, position data, and output data from the activity data; and
rendering, by the fitness device, a visualization of the activity data, the rendering comprising:
rendering icons representing the user data relative to a baseline, a distance of each of the icons to the baseline determined based on the output data and spacings between the icons determined based on the position data, and
rendering a curve, the curve connected to each of the icons.

2. The method of claim 1, wherein the output data includes an instantaneous power output of a respective user at a given timestamp.

3. The method of claim 2, wherein an item of the position data comprises a ranking of a respective user at a given timestamp.

4. The method of claim 1, wherein rendering the curve comprises rendering a base curve and adjusting a plurality of points of the base curve based on the activity data.

5. The method of claim 1, wherein rendering the curve comprises fitting a curve based on the activity data.

6. The method of claim 1, wherein the curve comprises a sinusoidal or polynomial curve.

7. The method of claim 1 further comprising:
transmitting, by the fitness device, a measured output to the server;
receiving, at the fitness device, updated activity data; and
adjusting, by the fitness device, the curve based on the updated activity data.

8. A non-transitory computer-readable storage medium for tangibly storing computer program instructions capable of being executed by a computer processor, the computer program instructions defining steps of:
receiving, at a fitness device over a network, activity data from a server, the activity data comprising data reported by other fitness devices during participation in an activity;
extracting, by the fitness device, user data, position data, and output data from the activity data; and
rendering, by the fitness device, a visualization of the activity data, the rendering comprising:
rendering icons representing the user data relative to a baseline, a distance of each of the icons to the baseline determined based on the output data and spacings between the icons determined based on the position data, and
rendering a curve, the curve connected to each of the icons.

9. The non-transitory computer-readable storage medium of claim 8, wherein the output data includes an instantaneous power output of a respective user at a given timestamp.

10. The non-transitory computer-readable storage medium of claim 9, wherein an item of the position data comprises a ranking of a respective user at a given timestamp.

11. The non-transitory computer-readable storage medium of claim 8, wherein rendering the curve comprises rendering a base curve and adjusting a plurality of points of the base curve based on the activity data.

12. The non-transitory computer-readable storage medium of claim 8, wherein rendering the curve comprises fitting a curve based on the activity data.

13. The non-transitory computer-readable storage medium of claim 8, wherein the curve comprises a sinusoidal or polynomial curve.

14. The non-transitory computer-readable storage medium of claim 8 further comprising:
transmitting, by the fitness device, a measured output to the server;
receiving, at the fitness device, updated activity data; and
adjusting, by the fitness device, the curve based on the updated activity data.

15. A device comprising:
a processor configured to:
receive, over a network, activity data from a server, the activity data comprising data reported by other fitness devices during participation in an activity;
extract user data, position data, and output data from the activity data; and
render a visualization of the activity data, the rendering comprising:
rendering icons representing the user data relative to a baseline, a distance of each of the icons to the baseline determined based on the output data and spacings between the icons determined based on the position data, and
rendering a curve, the curve connected to each of the icons.

16. The device of claim 15, wherein the output data includes an instantaneous power output of a respective user at a given timestamp.

17. The device of claim 16, wherein an item of the position data comprises a ranking of a respective user at a given timestamp.

18. The device of claim 15, wherein rendering the curve comprises rendering a base curve and adjusting a plurality of points of the base curve based on the activity data.

19. The device of claim 15, wherein rendering the curve comprises fitting a curve based on the activity data.

20. The device of claim 15, wherein the curve comprises a sinusoidal or polynomial curve.
